(19) United States
(12) Patent Application Publication
(10) Pub. No.: US 2023/0147925 A1
(43) Pub. Date: May 11, 2023

(54) PROTECTION AGAINST FRONT-RUNNING ATTACKS IN A DISTRIBUTED LEDGER

(71) Applicant: Robert Bosch GmbH, Stuttgart (DE)

(72) Inventor: Alexander Poddey, Wiernsheim (DE)

(21) Appl. No.: 17/975,753

(22) Filed: Oct. 28, 2022

(30) Foreign Application Priority Data
Nov. 9, 2021 (DE) 10 2021 212 599.9

(51) Int. Cl. G06Q 20/40; G06Q 20/38

(52) U.S. Cl. CPC G06Q 20/401; G06Q 20/3825

(57) ABSTRACT

A computer-implemented method for maintaining a distributed ledger by a first miner. A set of transactions may be selected from multiple transaction requests and included in a newly generated block for a distributed ledger. A goodness score may be computed by evaluating compliance to one or more selection rules. An amount of cryptographic tokens may be assigned to the miner proportional to the first goodness score.

### CROSS REFERENCE

The present application claims the benefit under 35 U.S.C. § 119 of German Patent Application No. DE 10 2021 212 599.9 filed on Nov. 9, 2021, which is expressly incorporated herein in its entirety.

### FIELD

The present invention relates to a computer-implemented method for maintaining a distributed ledger, a server device, a client device, and a computer readable medium.

### BACKGROUND INFORMATION

A decentralized transaction system, transaction database or distributed ledger is any protocol in computer networks that brings about consensus regarding its transactions and their sequence. A common form of such a system is based on a blockchain and forms the basis of many so-called cryptocurrencies. In a cryptocurrency, cryptographic tokens are distributed across multiple clients. The clients can transfer the tokens among each other, or to and from a market maker. Cryptography and distributed ledger systems ensure that a transfer cannot easily be forged or repudiated.

PCT Patent Application No. WO 2019/043668 A1 describes a blockchain, in this case, to track cryptocurrency tokens. Transactions related to the tokens, such as token creation or destruction is visible on the blockchain.

A distributed ledger such as a blockchain provides a secure transfer system. This allows, e.g., tokens of a first type to be exchanged for tokens of a second type. Colloquially, a token of the first type is bought, and has a price as an amount of tokens of the second type. Advanced cryptocurrencies use a mechanism known as “curved bonding”, according to which a function known as a bonding curve is algorithmically defined, which influences the price of units (tokens) of the currency depending on the current supply of tokens. Price is used loosely here to indicate the tokens that are exchanged, which do not necessarily have a monetary value. A token may represent any limited resource, e.g., access to computation resources or the like, and the cryptocurrency may be used to regulate access.

The conventional system describes managing a cryptocurrency with curved bonding. In the conventional method, a plurality of users are provided with an in-marketplace wallet, suitable for storing linked digital tokens that are linked in value to cryptocurrency tokens and that are required to transact on a digital marketplace platform. A cryptocurrency reserve is provided suitable for storing a plurality of cryptocurrency tokens. In response to a user purchasing linked digital tokens from a marketplace store, linked digital tokens are transferred to the in-marketplace wallet of the user and an equivalent value of cryptocurrency tokens are transferred to the cryptocurrency reserve. In response to a user withdrawing a number of linked digital tokens from the in-marketplace wallet of the user, the desired number of linked digital tokens is removed from the user's in-marketplace wallet and an equivalent value of cryptocurrency tokens is transferred from the cryptocurrency reserve to an out-of-marketplace wallet of the user, the out-of-marketplace wallet suitable for storing cryptocurrency tokens outside of the marketplace platform.

### SUMMARY

The conventional system is vulnerable to front-running attacks. A front-running attack exploits the technical properties of the system for its own purposes.

When front-running a buy or sell transaction, miners and other actors might extract value from normal participants. Two classes of front-running can be distinguished: on the one hand, there are short-termed to medium-termed or high-frequency front-running (hffr)—where the normal transactions are not substantially delayed, but an attack transaction is placed ahead and right after of the normal transaction(s) in the execution queue. For example, a miner may collude and place a transaction in the front of the queue. For example, a user with knowledge of an upcoming large transaction may associate a high transaction fee with his front-running transaction to induce the miner to prioritize his transaction. A miner is an electronic device typically in the form of a server device configured as a miner.

Collusion among a partition of the miners, may delay certain transactions for a longer time-frame, referred to as active censorship. The corresponding attack is referred to as censorship based front-running (cfr). An example would be placing a buy transaction, then blocking all sell transactions and only allow buy transactions, finally selling and hence extracting the value before processing the delayed sell transactions.

It is often accepted in distributed ledgers that both miners and clients can influence the order of transactions, principally through the height of the transaction fee associated with a transaction request-a client can prioritize their transaction request by associating a higher fee while a miner will be likely to select transaction requests with a higher transaction fee. This flexibility allows users to influence the processing of transactions-paying for a cup of coffee does not need fast processing, while for a large transaction the parties involved may prefer that the transaction is finalized quickly.

Unfortunately, the flexibility that allows influence on the order of processing of payments makes it acceptable and expected that sometimes a transaction may have to wait in line for longer than usual. This gives the opportunity for attacks. A miner and especially a set of colluding miners can first issue and process a buy transaction, and then suppress sell transaction for some time, followed by a sell transaction of the attackers. The buy and sell operation thus bracketing a period of censoring transactions.

Front-running attacks fall in a similar category as cryptographic attacks, denial of service, and the like. The technical properties of the system are exploiting to serve the purposes of the attacker. Such censorship attacks may be suppressed by non-technical measures, e.g., a miner may be obligated by law or contract not to engage in censorship, etc. Although a non-technical solution could be envisaged, e.g., a technical solution to the problem is preferred. The inventor realized that technical measures are indeed possible to mitigate these types of attacks.

If a censorship attack is in progress than some transaction will not be handled for a certain stretch of time. By reducing the fees that are garnered by server that do not progress old transactions, participating in the censorship attack can be made less attractive.

For example, a new block for the distributed ledger may include a set of transactions selected from multiple transaction requests that were received at the device, e.g., server device, e.g., miner. For example, they may be received from clients or from other miners.

The miner who finalizes the block, e.g., includes in the block a consensus token, may also assign to itself an amount of cryptographic tokens from the available funds related to a new block, e.g., the sum of newly minted tokens and transaction fees; part may be transferred to the miner of the block, part may be assigned somewhere else. For example, the part that is not assigned to the miner may be deposited in a pool, e.g., a wallet. For example, such a pool may be accessed by a governor, e.g., administrator of the distributed ledger. How many tokens become available, e.g., minted, when a new block is mined, may be determined by chain logic, but may also be determined by a smart contract.

In an example embodiment of the present invention, the part of the tokens available for assigning when finalizing a new block is computed from a first goodness score.

The goodness score reflects how well this miner follows a set of selection rules. Other miners can accept or reject the block not only based on the validity of the transactions, or the cryptographic consistency of the block but also based on the amount of tokens assigned to the miner.

In particular, the goodness score may be lower if older transaction requests are not selected; Especially if not selecting older transaction requests with high transaction fees are not selected. For example, goodness may be computed by counting unselected transaction requests that have particular combination of age and fees, e.g., as indicated by an urgency function. In a sense, a miner who receives a new block and knows that there are old transactions that reasonably should have been selected, e.g., as made objective in a selection rule, e.g., using an urgency function, knows that the other miner is—for whatever reason—manipulating the order of transactions beyond what is reasonably needed for a flexible system. By rejecting the block, the miner that proposed the block does not receive the associated fee that are assigned to it in the block.

It may be that transaction requests are not entirely synchronized at any one point between the miners, e.g., if transaction requests are distributed in a peer to peer manner. However, older transaction requests are typically synchronized, so this will not likely impact the computation of the goodness score unduly. This issue can be mitigated however by introducing synchronization of the transaction requests, e.g., to build an agreed list of transaction requests. This may be accomplished by periodically running a synchronization protocol among the miners. The transactions can then be selected for a new block from agreed transaction requests only. The synchronization may include exchanging an arrival time of the transaction requests so that all miners can verify the age of a transaction.

The list of agreed transaction requests may be maintained on a distributed ledger, which may be the same ledger or a further ledger. The list of agreed transaction requests may be exported, e.g., so that a client device can verify if its transaction request is included in it.

Making the transfer of tokens to a miner conditional upon its behavior mitigates censorship. This is important for example, if transactions are linked to a price that changes with the volume of buy/sell operations or the like. For example, in an embodiment a cryptocurrency exchanges tokens of a first kind for tokens of a second kind and vice versa, e.g., in a creation procedure and annulment procedure. In such an embodiment, the exchange rate may be established in the system, e.g., as a bonding curve, or derived from a bonding curve, e.g., by introducing a buy/sell spread. The prices of tokens can also fluctuate outside the direct control of the distributed ledger system. Whatever the reasons of exchange rates varying it is desirable that censorship based attacks can be mitigated.

Introducing a goodness score could be combined with other measures that make front running less attractive. For example, there may be a buy/sell spread-so that the buy price for a token is higher than the sell price of token. This makes front-running attack even less efficient.

The combination of a goodness score together with a buy-sell spread is especially beneficial since it generally renders short termed and/or high-frequency frontrunning held by anybody inefficient. At the same time, for censorship based attacks, it enforces a necessary timeframe in order for the attack to be economically beneficial for the attacker. This timeframe becomes large through a buy-sell spread, but this this gives the goodness score the time to pick up on the aberrant behavior of the miner and to step in. In other words, a buy-sell spread makes attacks, such as censorship attacks more ‘visible’ and hence punishable.

A goodness score may be used to enforce good behavior via transaction fees. In an example embodiment of the present invention, further measures may be triggered if goodness falls below a threshold. For example, such further measures may include, e.g., reducing stake, jailing the miner for a certain amount of time.

When a miner is jailed, he is excluded as an active miner for some amount of time. Accordingly, during that time he cannot mine new blocks and not obtain new tokens.

For example, if a goodness score drops below a threshold, or no longer fulfills determined criteria, e.g., as set out in a smart contract, or in a block, then in addition (or instead of) rejecting a block mined by the lacking miner, further a punishment routine may be trigged. The punishment routine may be defined in the chain logic, ledger protocol, smart contract or the like.

Punishing on the basis of a calculable goodness score has the advantage of being easily and objectively verifiable by the lacking miner itself, but by any other party interested in, e.g., the correct management of the system. This also avoids that part of the miners might collude to punish a miner undeserving of the punishment routine.

Stricter measures than just rejecting a block may be necessary. Consider, for example, a frontrunning attack that gains much value. This value gain may be much larger than the usual transaction fees and hence the punishment via the transaction fee proportion may be negligible compared to the gain made by the front running attack. Triggering a punishment routine, e.g., automatically, or manually, or as a hybrid, this behavior can be avoided.

Other elements that can enter in a goodness score beyond the tardy or non-handling of old transaction request may include, e.g., not validating blocks often enough, being offline too often, computing wrong values in a block, such as cryptographic values. These are important metrics; for example, if a miner is too often offline, this means that it is becomes easier to find a colluding majority of the remaining miners, thus reducing the security of the whole system.

For example, in an example embodiment of the present invention, a miner may compute a goodness score for another miner, and compare the goodness score with determined criteria, e.g., a threshold. If the comparison fails then a punishment routine may be triggered. For example, in an embodiment, a determined number of other miners also need to trigger the punishment routine.

For example, triggering the punishment routine and optionally the goodness score and/or the goodness score computation that lead to it, may be published in a block of the distributed ledger. If a sufficient number of other miners to the same, the smart contract may trigger the punishment routine. No other miners are necessary though, for example, the smart contract could recompute the goodness score by itself, and compare to its own criteria to reach triggering or not of the punishment routine.

A goodness score may be a numerical score. A goodness score may comprise multiple numerical values. A criterion for goodness evaluation may be that the numerical value or values have to be above or below respective thresholds. For example, different values may represent different aspects of goodness, e.g., offline time, backlog of old transactions, and the like.

The combination of a buy-sell spread, e.g., different prices for sell and buy transaction in combination with goodness score based triggering of punishments, make both short-term and censor ship frontrunning difficult.

In an example embodiment of the present invention, cryptographic tokens of a first type are maintained by a smart contract. Smart contracts are an advantageous way to create a new cryptocurrency on distributed ledgers that support smart contracts. A smart contract is not necessary though. For example, a market maker implementing the same procedures as the smart contract could be part of the chain logic, e.g., of the chain-application layer. A user can call the procedures as if were a smart contract defined on the ledger, even though the smart contract is implemented elsewhere. Embodiments using a smart contract can be converted to an embodiment without a smart contract by incorporating the functions of the smart contract into the chain logic, e.g., the software that runs the distributed ledger. The smart contract may implement a creation procedure for creation cryptographic tokens of a first type, in exchange for cryptographic tokens of a second type. For example, The smart contract may implement an annulment procedure for annulling cryptographic tokens of a first type, in exchange for cryptographic tokens of a second type. The second type tokens may be an established cryptocurrency, e.g., bitcoin, ether, etc. The smart contract can also maintain information relating concerning the first type tokens, in particular, a current supply size indicating a current number of crypto tokens of the first type and a bonding curve defining a function.

For example, the amount of crypto tokens of the second type for the exchange may be computed by integrating a function from the current supply size to a new supply size. The function being a sum of the bonding curve and a number of further terms, for at least one of the creation and annulling procedures the further terms including a fee term comprising a multiple of the bonding curve shifted over an amount of crypto tokens of the first type.

For example, in case the creation procedure is triggered, the integration may be done over a creation function, while for annulment an annulment function may be used. The creation function may be higher than the annulment function. For example, the creation function may be higher than a bonding curve, while the annulment function may be lower than a bonding curve. The bonding curve is an increasing function.

An aspect of the present invention is a server device for maintaining a distributed ledger. For example, the server device may be a miner. An aspect of the invention is a client device.

For example, the client device may be used by a user, e.g., to use the distributed ledger, e.g., to send transaction requests.

If a further cryptocurrency is created on the distributed ledger, possibly using a smart contract, then the transaction requests may initiate creation or annulment requests in the smart contract.

On a distributed ledger that allows smart contracts, preventing censorship is especially important because any number of cryptocurrencies could be created on the distributed ledger. Embodiments herein continue to allow flexibility in selecting requests, while mitigating abuse.

A further aspect of the present invention is a method for maintaining a distributed ledger. An example embodiment of the method may be implemented on a computer as a computer implemented method, or in dedicated hardware, or in a combination of both. Executable code for an embodiment of the method may be stored on a computer program product. Examples of computer program products include memory devices, optical storage devices, integrated circuits, servers, online software, etc. Preferably, the computer program product comprises non-transitory program code stored on a computer readable medium for performing an embodiment of the method when said program product is executed on a computer.

In an example embodiment of the present invention, the computer program comprises computer program code adapted to perform all or part of the steps of an embodiment of the method when the computer program is run on a computer. Preferably, the computer program is embodied on a computer readable medium.

Another aspect of the present invention is a method of making the computer program available for downloading.

### BRIEF DESCRIPTION OF DRAWINGS

Further details, aspects, and embodiments will be described, by way of example only, with reference to the figures. Elements in the figures are illustrated for simplicity and clarity and have not necessarily been drawn to scale. In the figures, elements which correspond to elements already described may have the same reference numerals.

FIG. 1A schematically shows an example of an embodiment of a client device, according to the present invention.

FIG. 1B schematically shows an example of an embodiment of a server device, according to the present invention.

FIG. 1C schematically shows an example of an embodiment of a distributed ledger system, according to the present invention.

FIG. 2 schematically shows an example of an embodiment of a blockchain, according to the present invention.

FIG. 3A schematically shows an example of an embodiment of a distributed ledger system, according to the present invention.

FIG. 3B schematically shows an example of an embodiment of a distributed ledger system, according to the present invention.

FIG. 4 schematically shows an example of an embodiment of a method for maintaining crypto tokens of a first type, according to the present invention.

FIG. 5A schematically shows a computer readable medium having a writable part comprising a computer program according to an embodiment, according to the present invention.

FIG. 5B schematically shows a representation of a processor system according to an embodiment, according to the present invention.

### REFERENCE SIGNS LIST

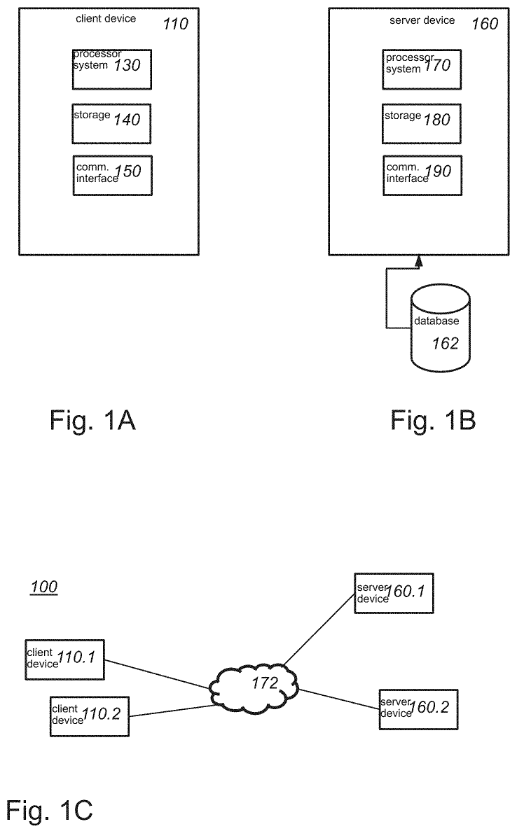

The following list of references and abbreviations corresponds to FIGS. 1A-3B, 5A, 5B, and is provided for facilitating the interpretation of the figures and shall not be construed as limiting the scope of the present invention.
100 a distributed ledger system
110, 110.1, 110.2 a client device
130 a processor system
140 a storage
150 a communication interface
160, 160.1, 160.2 a server device
162 a database
170 a processor system
180 a storage
190 a communication interface
172 a computer network
210 a blockchain
211-215 a block
220 a smart contract
221 a create procedure
222 an annulment procedure
223 an update procedure
231-234 a state
241-242 a crypto token transfer
251-253 a point in time
300 a distributed ledger system
301-303 a server device
311, 312 a client device
320 a peer to peer link
316 a client to server link
331 a transaction aggregator
1000, 1001 a computer readable medium
1010 a writable part
1020 a computer program
1110 integrated circuit(s)
1120 a processing unit
1122 a memory
1124 a dedicated integrated circuit
1126 a communication element
1130 an interconnect
1140 a processor system

### DETAILED DESCRIPTION OF EXAMPLE EMBODIMENTS

While the present invention is susceptible of embodiments in many different forms, there are shown in the figures and will herein be described in detail one or more specific example embodiments, with the understanding that the present disclosure is to be considered as exemplary of the principles of the invention and not intended to limit it to the specific embodiments shown and described.

In the following, for the sake of understanding, elements of embodiments are described in operation. However, it will be apparent that the respective elements are arranged to perform the functions, e.g., procedures, being described as performed by them.

Further, the subject matter that is presently disclosed is not limited to the embodiments only, but also includes every other combination of features disclosed herein.

FIG. 1A schematically shows an example of an embodiment of a client device 110. FIG. 1B schematically shows an example of an embodiment of a server device 160.

For example, server device 160 may be configured to maintain a distributed ledger. The server device is configured as a miner, and is sometimes referred to as a miner, or mining device, or as a minter, or minting device. For example, server 160 may be configured to generate a new block for the distributed ledger including a selected set of transactions. The transaction may be selected by the server device from transactions that it received. Some amount of cryptographic tokens are assigned to the miner. For example, tokens may be a cryptocurrency. For example, the cryptocurrency may be associated with the distributed ledger. For example, the cryptocurrency may be bitcoin, ether, or the like.

Although the server device, that is the miner device, has freedom in selecting transactions from the transactions requests known to the server device, there is an interest in keeping the selection within certain bounds. In particular, it is preferred if transactions are not left unprocessed too long. For example, the server may be configured to compute a goodness score assigning tokens to himself in dependence on the goodness score. Examples are given herein.

For example, client device 110 may be configured to maintain a wallet. For example, the client device 110 may be configured to send a transaction request to server device 160, e.g., to transfer tokens from the wallet to a further wallet. The transaction when processed will be reflected in a block on the distributed ledger. Also server device 160 may have access to a wallet, possibly by execution of a procedure of a smart contract.

Client device 110 may comprise a processor system 130, a storage 140, and a communication interface 150. Server device 160 may comprise a processor system 160, a storage 180, and a communication interface 190. Storage 140 and 180 may be electronic storage. The storage may comprise local storage, e.g., a local hard drive or electronic memory. Storage 140 and 180 may comprise non-local storage, e.g., cloud storage. In the latter case, storage 140 and 180 may comprise a storage interface to the non-local storage.

Client device 110 and server device 160 may be part of a distributed ledger system. Client device 110 and server device 160 may communicate internally, with other systems, external storage, input devices, output devices, and/or one or more sensors over a computer network. The computer network may be an internet, an intranet, a LAN, a WLAN, etc. The computer network may be the Internet. The system comprises a connection interface which is arranged to communicate within the system or outside of the system as needed. For example, the connection interface may comprise a connector, e.g., a wired connector, e.g., an Ethernet connector, an optical connector, etc., or a wireless connector, e.g., an antenna, e.g., a Wi-Fi, 4G or 5G antenna.

The communication interface 150 may be used to send or receive digital data, e.g., transaction requests to transfer cryptographic tokens, e.g., representing a cryptocurrency, and requests to execute creation or annulment procedures of a cryptocurrency; said procedure may be part of a smart contract. The communication interface 190 may be used to send or receive digital data, e.g., transaction requests to transfer cryptographic tokens. The communication interface 190 may be used to communicate with other server devices, e.g., to distribute a new block of a blockchain, or to synchronize transaction requests.

The execution of devices 110 and 160 may be implemented in a processor system, e.g., one or more processor circuits, e.g., microprocessors, examples of which are shown herein. The processor system may comprise one or more GPUs and/or CPUs. Devices 110 and 160 System 100 may comprise multiple processors, which may be distributed over different locations. For example, devices 110 and 160 may use cloud computing.

The devices 110 and 160 may comprise functional units that may be functional units of the processor system. For example, the functional units shown may be wholly or partially implemented in computer instructions that are stored at the device, e.g., in an electronic memory of the device, and are executable by a microprocessor of the device. In hybrid embodiments, functional units are implemented partially in hardware, e.g., as coprocessors, e.g., cryptographic coprocessors, and partially in software stored and executed on the device.

FIG. 1C schematically shows an example of an embodiment of a distributed ledger system. System 100 comprises multiple client devices; shown are client device 110.1 and 110.2. System 100 comprises multiple server devices; shown are server device 160.1 and 160.2. The devices are connected through a computer network 172, e.g., the internet. The client and server device may be according to an embodiment. The client devices may cooperate among each other to transfer cryptographic tokens. The client devices may interact with a server device to transfer a cryptographic token from a first wallet to a second wallet. A client device may request a server device to execute a creation procedure to create new tokens of a type of cryptocurrency, possibly in exchange for tokens of another type of cryptocurrency. A client device may request a server device to execute an annulment procedure to annul tokens of the type of cryptocurrency, possibly in exchange for tokens of the other type of cryptocurrency. Creation is also sometimes referred to as a buying, while annulment is sometimes referred to as destroying or selling.

Storage may be implemented as an electronic memory, say a flash memory, or magnetic memory, say hard disk or the like. Storage may comprise multiple discrete memories together making up storage 140, 180. Storage may comprise a temporary memory, say a RAM. The storage may be cloud storage.

Typically, the client device 110 and server device 160 each comprise a microprocessor which executes appropriate software stored at the system; for example, that software may have been downloaded and/or stored in a corresponding memory, e.g., a volatile memory such as RAM or a non-volatile memory such as Flash. Alternatively, the systems may, in whole or in part, be implemented in programmable logic, e.g., as field-programmable gate array (FPGA). The systems may be implemented, in whole or in part, as a so-called application-specific integrated circuit (ASIC), e.g., an integrated circuit (IC) customized for their particular use. For example, the circuits may be implemented in CMOS, e.g., using a hardware description language such as Verilog, VHDL, etc. In particular, client device 110 and server device 160 may comprise circuits for the cryptographic processing, and/or arithmetic processing.

A processor circuit may be implemented in a distributed fashion, e.g., as multiple sub-processor circuits. A storage may be distributed over multiple distributed sub-storages. Part or all of the memory may be an electronic memory, magnetic memory, etc. For example, the storage may have volatile and a non-volatile part. Part of the storage may be read-only.

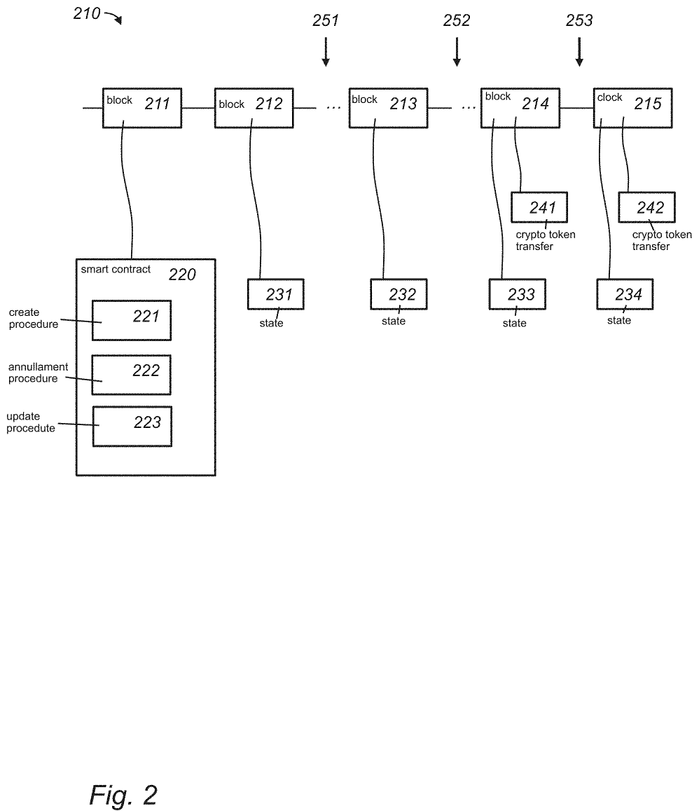

FIG. 2 schematically shows an example of an embodiment of a blockchain 210. Blockchains are particular example of distributed ledgers that has shown to work well in embodiments. Other examples of distributed ledgers can also be used. For example, in an embodiment the distributed ledger may be a hash graph, a tangle or a lattice. The distributed ledger comprises multiple blocks, which are linked to each other. The blocks may comprise transactional data and metadata. The metadata may comprise linking information and a consensus mechanism. Embodiments are primarily described with reference to a blockchain, but such an embodiment could be changed to use another type of distributed ledger, in particular a graph based one.

Blockchain 210 comprises multiple blocks, which are linked to each other in a sequence. For example, the linkage may comprise a consensus mechanism. For example, such a mechanism may be a proof of work, e.g., as in Bitcoin. The mechanism may be a proof of stake. A consensus mechanism allows distributed trust in the distributed ledger. Other consensus mechanism, e.g., as conventional in the art may be used in an embodiment.

To aid the discussion, FIG. 2 shows three points in the blockchain: points 251, 252, and 253, corresponding to three moments in time. At point 251, blocks up to block 213 have been created, but not yet block 213. At point 252, blocks up to block 214 have been created, but not yet block 214. At point 253, blocks up to block 215 have been created, but not yet block 215.

Show in blockchain 210 are multiple blocks, in this case, 5 blocks: blocks 211, 212, 213, 214, and 215. There may be more or fewer blocks. A block may comprise data related to the distributed ledger mechanism, e.g., consensus data, but also other information. In particular a block may comprise transactions, in which tokens are bound to an address, e.g., related to the public key of a client, e.g., as incorporated in a client device. Blocks may also include other information.

A block in the distributed ledger is created by a miner who has capability to create the consensus information, whether it is proof of stake or proof of work or the like. Typically, a miner, e.g., a server device, receives multiple transactions, e.g., directly from user or from other miners that share transactions they received with each other. From the received transactions a selection is made, which in turn is included in the new block of the distributed blockchain. A part of the total amount of cryptocurrency tokens that is associated with the new block, e.g., tokens minted by the creation of the block itself, and the transaction fees associated with the included transactions, may be transferred to the miner, e.g., in the very block just mined.

The distributed ledger may implement a cryptocurrency. For example, the creation of new blocks may also create new crypto tokens of the cryptocurrency. The miners typically receive all or part of the newly minted cryptocurrency. The crypto tokens are linked to a particular cryptographic identity, e.g., address or cryptographic key.

Interestingly, once a distributed ledger exists further cryptographic currencies can be created using it, e.g., by using a smart contract. For example, a block in the distributed ledger may comprise a smart contract. Block 211 shows an example, in the form of a smart contract 220. A smart contract is typically written in a computer language. An example of a computer language that is optimized for smart contracts is solidity. For example, in an embodiment blockchain 210 may be the Ethereum blockchain, and the smart contract may be written in solidity.

It is not required to restrict to a particular language or blockchain though. For example, the Ethereum blockchain may be used as described in the paper “Ethereum: a secure decentralised generalised transaction ledger”, by G. Wood, e.g., the Istanbul version 80085f7 of 2021-07-11.

For example, in an embodiment, a server configured to maintain crypto tokens of a first type may be configured to obtain the smart contract from the distributed ledger. For example, the smart contract may be stored in a block of the distributed ledger. The smart contract may implement the needed procedures, e.g., a creation procedure for creating the crypto tokens of the first type and an annulment procedure for the annulment of crypto tokens of the first type. The smart contract may be configured to maintain the current supply size. The smart contract may define a bonding curve.

In an embodiment, blockchain 210 is used to create and annul cryptographic tokens of a first type. Colloquially, creating new cryptographic tokens is sometimes referred to a ‘buying’ the tokens; annulling a cryptographic token is sometimes referred to as ‘selling’ the tokens.

The smart contract implements multiple procedures, including at least a create procedure 221 and an annulment 222 (also called a sell procedure). Optionally, the contract may implement an update procedure 223. Colloquially, the create procedure is also called a buy procedure and the annulment procedure 222 a sell procedure. This is not entirely accurate as typically the tokens no longer exist once they are annulled. The total supply of tokens decreases after an annulment action. The annulment procedure is also referred to as a destroy procedure.

The server executes the create procedure and as a result obtains a new state. For example, the new state may reflect the increased number of crypto tokens of the first type that are now in existence (referred to as the supply). The server may also obtain a transaction that indicates that the new cryptographic tokens are transferred to the first user, and/or a transaction that indicates that the existing cryptographic tokens of the second type are transferred from the first user to a wallet associated with the smart contract. The smart contract is referred to as the market maker. An amount of second type tokens may be kept in reserve by the market maker, e.g., in wallet.

This part of the wallet is referred to as the pool or pool balance. The same wallet may be used to hold tokens not part of the pool. One may also reserve use of this wallet for only the pool.

The server client writes on the blockchain, e.g., includes in a block, the new state, and the new crypto tokens of the first type, the transferred crypto tokens of the second type are written on this or another blockchain. Tokens of the first type and the state may be put on separate blockchains as well.

Suppose a first user wants to buy a number of crypto tokens of a first type. He/she sends a request through a client device to a server device. The request may be sent to multiple server devices. The request may include, e.g.,
the amount x crypto tokens of a first type requested
instructions to transfer y crypto tokens of a second type
an address to bind the crypto tokens of a first type to.

For example, consider that the request is sent at point 252, just before clock 214 is created.

The server device retrieves the smart contract 220 from the blockchain. The smart contract uses a state which may be updated. The server device retrieves the current state from the blockchain. Blockchain 210 shows states 231 and 232 before point 252, so that the server device retrieves state 232.

To determine the amount of cryptographic tokens of the second type (y) that are exchanged for an amount of cryptographic tokens of the first type (x), colloquially referred to as the price, the smart contract uses a bonding curve. The smart contract may comprise a definition of the bonding curve. The definition of the bonding curve may also be in a state. The definition of the bonding curve may be the smart contract, until a new definition in a written state overrides it. Note that a bonding curve is typically increasing or at least is non-decreasing.

In an embodiment, the smart contract is not stored in a block but is accessible to the server through other means; for example, the smart contract may be obtained before executing said procedures. Using a smart contract may have the advantage that a proof of execution, e.g., of any particular procedure, can be placed on the distributed ledger. Note that even if a smart contract is not placed on the chain, it can still be executed as one, provided other miners have access to its code.

In fact, the procedures need not even be implemented in a smart contract but may be implemented in conventional software. For example, such software may be obtained by the server before execution. The software may be part of the chain logic software that defined the mining operation.

In an embodiment, the market maker, e.g., the smart contract or other software, could be part of the chain-application layer. A user may call the procedures like in a smart contract.

If no smart contract is used, the wallet or pool associated with the smart contract may be replaced with a wallet or pool associated with the market maker, e.g., with the software that implements the cryptocurrency.

Note that cryptocurrencies can be created with or without a smart contract. No creation or annulment procedures are needed. For example, cryptocurrency can be maintained by chain logic, e.g., software defining the distributed ledger. However, if the distributed ledger is configured for smart contracts, then a fair processing of the transactions becomes even more important.

A potentially unlimited number of cryptocurrencies may be defined on such a distributed ledger, and each of them relying on fair processing of transactions, and are potentially vulnerable to

Note also that transactions on a chain may relate to the transfer of a cryptocurrency, whether defined by a smart contract or not, but may also relate to other transaction.

Distributed ledgers can be used to securely store all kinds of information.

For completeness, a computer-implemented method for maintaining crypto tokens of a first type on a distributed ledger, may comprise
creating crypto tokens of the first type in exchange for crypto tokens of the second type and annulling crypto tokens of the first type in exchange for crypto tokens of the second type, maintaining a current supply size on the distributed ledger indicating a current number of crypto tokens of the first type. The creating, annulling, etc., may be defined in chain logic, or may be defined in a smart contract, e.g., stored in a block of the distributed ledger. If a bonding curve is used, then the amount of crypto tokens of the second type for the exchange may be computed by integrating a function from the current supply size to a new supply size. The function may be the bonding curve or derived therefrom, e.g., a bonding curve and a fee term. For example, for creation, e.g., as defined in a creation procedure, the server device may, transfer an amount of crypto tokens of the second type to a pool, and transferring the amount of crypto tokens of the first type, e.g., to a wallet, and increase the current supply size with the amount of crypto tokens of the first type. For example, for annulling, e.g., as defined in an annulment procedure, the server device may transfer the amount of crypto tokens of the second type from a pool, and invalidate the amount of crypto tokens of the first type, and decrease the current supply size with the amount of crypto tokens of the first type, and invalidating the amount of crypto tokens of the first type.

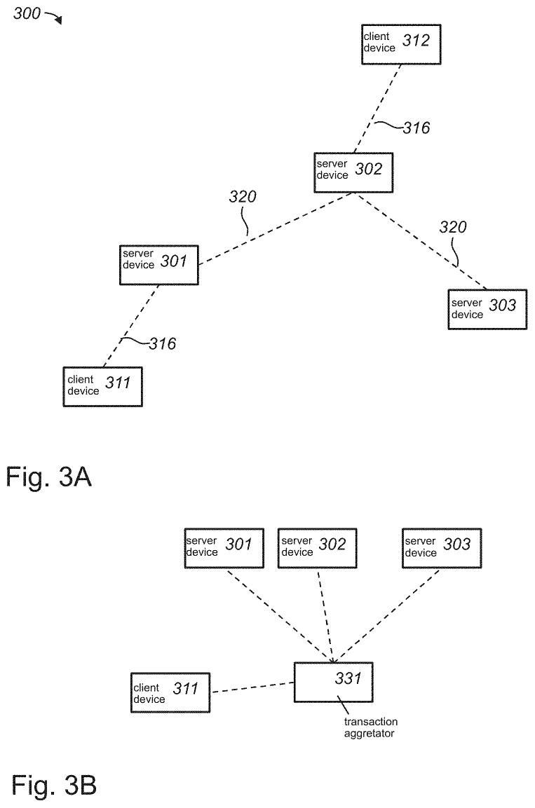

FIG. 3A schematically shows an example of an embodiment of a distributed ledger system 300. Distributed ledger system 300

Distributed ledger system 300 comprises multiple server devices. The server devices are configured as miners for the distributed ledger system; the server devices are configured to validly generate new blocks of the distributed ledger. Shown in FIG. 3A are three server devices: server device 301, 302 and 303. There may be two server devices; there may be more than three server devices.

Distributed ledger system 300 comprises multiple client devices. The client devices are configured as clients for the distributed ledger system; the client devices are configured to send transaction requests to a server device. A transaction request may request transfer of a crypto token, e.g., a cryptocurrency token, from one wallet to another, e.g., to associate the token from one address to another, e.g., to associate it from one cryptographic key to another. Shown in FIG. 3A are two client devices: client device 311, and 312. There may be more than two client devices.

Server devices and client devices are electronic devices, e.g., they may comprise a computer.

The server devices are interconnected among each other. For example, this may be done using a peer-to-peer network. FIG. 3A shows peer to peer links 320. In this case between server devices 301 and 302 and between server devices 302 and 303. The may be server devices between which there is no direct connection, e.g., between server devices 301 and 303.

Client devices are connected to server devices with a client to server link 311. For example, shown in FIG. 3A, client device 311 is connected to server device 301 and client device 312 is connected server device 302. Both client to server links and the peer to peer links may be implemented using a computer network, e.g., the internet.

A client device may be configured to send a transaction request to a server device. A server device is configured to receive multiple transactions for inclusion in the distributed ledger. The server device may receive a transaction request directly from a client; e.g., server device 301 may receive a transaction request directly from client device 311, e.g., over connection 316. However, the server device may also implement a peer-to-peer synchronization protocol. For example, a first server device may send the transactions he received from a client device to a second server device.

For example, a transaction request that server device 301 may receive from client device 311 may be forwarded by server device 301 to server device 302, and in turn to server device 303. Note that even though server devices 301 and 303 do not have a direct link, they still exchange transaction requests in a peer-to-peer manner. In an embodiment, transaction requests are received in a decentral way. A disadvantage of this approach is that the pool of potential transactions to include in a block is not at all times to same for all miners. Solutions to this issue are presented below.

An advantage of peer-to-peer networking is that the topology of the network need not be predetermined. So long each server device knows, e.g., stores, one or more computer addresses of other server devices, and while the network remains connected, full connectivity remains possible. Instead of a peer-to-peer network, alternative communication technology could be used. For example, the network could be fully connected, with each server device communicating with each other server device. For example, the network could be centralized. For example, to distribute a transaction request or new block, etc., it can be sent to a central server device, who in turn distributes it to the other server devices.

A server device is configured to generate a new block for the distributed ledger. To do this, the server device selects a set of transactions from the multiple transaction requests that it received. The set of transactions is included in a block, possibly following some reformatting, or rewriting. A transaction and a transaction request may include which token is to be transferred from which address to which other address. A transaction may also be related to a smart contract. For example, a transaction request may trigger a creation procedure or annulment procedure of a smart contract. For cryptocurrencies that are created through a smart contract front running attacks are also a threat.

The server device further includes in the block a consensus token. The consensus token depends on the particular type of distributed ledger, e.g., it may be the solution to a cryptographic problem, e.g., in a proof of work system (PoW), or it may be consensus token to show proof of stake (PoS) or proof of authority (PoA). The block may further indicate the server device, e.g., the miner, that created the block, e.g., including a digital signature of the server device.

The miner will also assign to itself some amount of cryptographic tokens. There are various options where these tokens can come from, depending also on the particular type of distributed ledger. For example, by mining a new block of the distributed ledger, e.g., of a blockchain, some amount of cryptocurrency may be created, e.g., as in bitcoin. All or part of this amount of cryptocurrency may be assigned to the server device, e.g., to the miner, that created the block. A second source of cryptocurrency can come from the transactions themselves. A transaction request can have associated with it a transaction fee. All or part of the fee may be assigned to the server device that mined the new block. Transactions may also be part of the execution of smart contracts. The execution of smart contracts also comes with transactions fees, all or part of which may be assigned to the server device that performs the execution and provides proof thereof in the newly generated block.

Typically, a server device has freedom in selecting the transaction to be included in a block. This can be beneficial, e.g., if not all server devices have access to the same transactions. In such a case, a transaction might not be selected simply because the server device did not know about it. A server device may also prioritize transactions that carry a larger fee. In itself this is not necessarily bad. If a transaction should be executed quickly, a user can associate it with a high transaction fee so that it will be quickly picked up. If execution of a transaction is not particular pressing, a lower transaction fee can be assigned. This may mean that it will take a while before a server device picks it up, but costs are lower.

Unfortunately, a fully free selection of transactions exposes the distributed ledger system to a class of attacks known as censorship based front running. In front running, an attack brackets a buy and sell transaction around a string of buy transactions. The string of buy transaction will drive the price of the cryptocurrency up, so that the attacker's subsequent sell transaction will gain a higher price than the attacker's buy transaction in the bracket cost. To perform the attack, the attacker needs to know that a string of buy transactions is coming up, or at least a string of mostly buy transaction. This can be achieved, if a server device, or even multiple server devices, illegally, agree not to select sell transaction for a while. When the bracketing sell transaction has been processed, the backlog of sell transactions is handled.

In other words, server devices can exploit their power to select transactions for including in a new block to enable attacks on the distributed ledger system. These attacks hold many types of cryptocurrency, so long the price of a token rises with demand one can perform a censorship front-running attack. The attack is in particular possible against bonding curve based cryptocurrency, e.g., implemented in a smart contract or in chain logic. The price of cryptocurrency linked to a bonding curve is linked to the volume of tokens in existence, thus a string of buy transactions (or create transactions) will have a higher price as a result.

Censorship based frontrunning may be mitigated by making it less attractive for server devices to participate in such an attack. For example, in an embodiment, the cryptographic tokens that are assigned to a server device for successfully completing a new block may be dependent on a goodness score. The goodness score may be computed by a server device by evaluating its compliance to one or more selection rules. The selection rules indicate how transactions for a new block of the distributed ledger should be selected, or giving bounds on what transactions ought to be selected.

When a block is finalized the server device allocates a part of the available fees for the block to itself based on that miner's goodness. Remaining tokens may be allocated elsewhere, either implicitly or explicitly. For example, the distributed ledger may be configured that all unallocated tokens are automatically collected in a pool, e.g., a wallet. For example, the miner may explicitly allocate the remaining tokens elsewhere, e.g., the pool, a wallet, return them to the originators of the transactions.

When the block is finalized, the new block may be transferring to one or more further miners. For example, say server device 301 finalized a block, it may send the block to server device 302, who will eventually send it to server device 303. Direct or centralized communication is also possible.

In an embodiment, a server device could allocate a larger part of the available fees to itself, but this can be caught and corrected by the other server devices.

For example, suppose a first miner, say server device 301, computes a new block, including assigning tokens to itself. When the block is received by other server devices, they will verify the transactions in the block, e.g., if the transaction represent valid transfers of tokens, e.g., from a first wallet to a second wallet, or represent a valid execution of a smart contract, or part of a valid execution. A server device, say server device 302, that receives a purported new block, will also verify if the tokens assigned by its miner, e.g., server device 301, are justified, in particular are justified by its goodness score. If either verification fails, e.g., of the transactions validity or of the assigned tokens, then the block is rejected.

The goodness score may be computed by the miner, e.g., server device, that generates a new block, as well as by a miner that verifies the new block. The goodness score indicates compliance of the miner that generated the new block to selection rules. The selection rules indicate how transactions for a new block are to be selected from the transaction requests available to the miner for inclusion. For example, a selection rule may require that a transaction request that is older than a first threshold and has a transaction fee that is higher than a second threshold should be selected. For example, a selection rule may require that a transaction request that is older than a first threshold and has a transaction fee that is at least as high as any unselected more recent transaction request should be selected. The number of violated rules may count toward a penalty. For example, the number of penalties may be a percentage that reduces the allocated tokens, etc.

In addition to selection rules, there may be other rules that indicate the portion of tokens that are available to a miner. For example, a rule may set a desired uptime, a quality of service, a maximum latency for generating a new block. Such rules may be called goodness rules, of which selection rules are a particular important example.

The goodness rules may be set in the software governing the server devices, e.g., in chain logic. The goodness rules may be fixed in principle, though they may be changed by updating the software of the server devices. The goodness rules may be published, and available to the server devices. In particular, the goodness rules may be published in a block of the distributed ledger. For example, the goodness rules may be set by a smart contract. The goodness rules can be changed, e.g., by a governor of the system, or by the smart contract. For example, new goodness rules may be published in a new block of the distributed ledger. New rules may be published automatically by a smart contract. For example, a smart contract may be triggered to adjust existing rules. For example, if growth in a pool associated with the smart contract, e.g., in which part of the tokens associated with a new block are deposited stays behind a target. New rules may also be posted manually, e.g., in a block. If a backlog of transaction requests grows, then penalties for not selecting old transactions may be increased. Such rule changes may be introduced automatically, e.g., by a smart contract. For example, if a smart contract is triggered by a condition a rule change may be implemented.

Selection rules are an important application of goodness rules as they help to make censorship based frontrunning unprofitable. If the tokens that are lost by a set of colluding server devices by engaging in censorship, due to the associated breaking of selection rules, is more than is gained by the censorship attack than the attack is no longer profitable, or at least its profitability has been reduced. This technical measure makes it unlikely that a server device will be tempted to engage in censorship as this type of attack on the system no longer works.

For example, in an embodiment, transaction requests have an age, and wherein compliance is evaluated lower if transaction requests with an old age are not selected. For example, the age of a transaction request may be the difference between a current time and date and the time and date that the transaction request was first sent to a server device.

A selection rule may be to pick the oldest transactions available. A selection rule may compute a transaction fitness, e.g., as a function of age and transaction fee and pick the highest ones. The basis is the transaction fee appended to the transaction requests on the one hand and the age on the other.

For example, a function can indicate the urgency of a transaction as a function of the transaction fee t appended to the transaction requests, and the transaction's age a. For example, an urgency function could be the product at or the sum a+t. For example, the age and fee can be weighted in the sum or product, e.g., γat, or, say, a^{γ1} t^{γ2}, or γ₁a+γ₂t, etc. For example, the urgency function can be a polynomial in the sum or product, and/or in their weighted variants, etc. Generally speaking the urgency function can be a bivariate function increasing in both variables.

A transaction requests can be regarded as urgent if its urgency function exceeds a threshold. A server device may be penalized, e.g., receive a reduced part of the transaction fees, if urgent transaction requests are not handled.

In an embodiment, an amount of a transaction fee of a transaction is transferred to a pool, e.g., a percentage. The percentage may decrease over age. The effectively retrieved fee by the miner thus becomes larger for older transaction requests and the tokens collected in the pool may be transferred to a server device that handles old requests to additionally incentivize the mining of elder transaction requests.

For example, when a first miner, e.g., a server device, e.g., server device 301, receives a purported new block of the distributed ledger from another miner, e.g., server device 302, then the first miner, e.g., server device 301 will engage in a number of checks to see if the block can be accepted as valid. The server device will verify conventional checks. For example, if the block contains a transfer of a token from a first wallet to a second wallet, then the server device may verify if the token was actually bound to the first wallet, or that the first wallet had sufficient funds, or the like. If the transaction relates to the execution of a smart contract, then the server device may verify that the correct execution corresponds to the transaction. For example, creation and annulment transactions may be visible on the ledger as transactions that show execution of a smart contract.

The server will also verify if the tokens that are assigned to the second server device to itself are correct. For example, the first server device may compute the goodness score again, e.g., by evaluating again the compliance of the second miner to the one or more selection rules. From the goodness score the amount of fees that can be assigned can be computed.

If any of the checks fail, then the block is rejected. This means that the second miner will not actually receive the funds, as the new blocks will not become part of the distributed ledger.

Thus in an embodiment, one miner proposes, the others verify—and thereby form the consensus about the incentives/goodness and validity of the block. For example, in an embodiment, a committee of miners may work together according to a certain protocol for proposing a block. One miner then proposes the block. Which miner gets to propose the next block may be selected from the members, e.g., according to a miner selection protocol or rule. The miners then validate the block. In validating they could also determine the goodness score, etc. and form a consensus about the mining reward. This embodiment works well with a PoS or PoA system.

In an embodiment, a set of multiple server devices are configured to select one server device among them for proposing the new block, the selected server device generates the new block and the remaining server devices validate the new block. In an embodiment, select one server device is combined with creating an agreed transaction requests list.

The transaction requests that are visible to each of the server devices may not always be identical. Especially when a peer to peer protocol is used to distribute transaction requests the view that each server device has of the transaction requests may differ. A server device may even have an incentive not to distribute some requests, e.g., as part of a censoring attack, or to avoid that a transaction request with a particular high transaction fee is handled by a competing server device.

These problems can be mitigated by first building an agreed list of transaction requests from which transactions must be selected for a new block. If transactions are included in a new block that were not on the agreed transaction requests list, then the new block may be rejected by the other server devices.

For example, in an embodiment, the server devices may be configured for a synchronization protocol in which transaction requests for inclusion in the distributed ledger are synchronized. For example, the server device may continue to forward transaction requests to each other, but occasionally a server device creates a snapshot of its pending transaction requests list and forwards it to the other server devices. The other server devices may accept the list as valid, e.g., because of a special status of the server device. A protocol may be used to select a server device for the new agreed transaction requests list.

An advantage of an agreed transaction requests list is that goodness scores can be computed deterministically at each server device. Another advantage is that it is clear from such a list if a server devices is tampering with the selection process, e.g., by censoring sell or buy transactions. Such server devices can be punished through its goodness score, but possibly also through an out-of-bound mechanism, e.g., excluding the server device from the distributed ledger system.

For example, a miner may put a transaction request on a global transaction requests list. A miner who does not select an old transaction request may be punished. For example, a verifying miner may compute an age of a transaction in a new block by comparing the transaction in the block with a timestamp of the transaction in the transaction requests list.

In an embodiment, a server device is configured to generate a list of agreed transactions for inclusion in the distributed ledger with a set of miners, and selecting the set of transactions from the agreed transactions.

For example, the miners may generate a list of agreed transaction requests in the pool, and every miner signs a hashed transaction requests pool list or similar.

Agreeing on a list of transaction requests may be done through a centralized device, e.g., as discussed below. Agreeing on a list of transaction requests may also be done through a multiparty computation. For example, to reach agreement, the server devices may be configured for a detectable broadcast protocol.

Detectable broadcast lets a party send a message to all parties, e.g., all server devices, so that either all parties receive the same message, or all parties agree that the broadcast has failed. Unlike full broadcast, the detectable broadcast can be achieved over private channels such as a peer to peer network.

See, e.g., the paper “Unconditional Byzantine agreement and multi-party computation secure against dishonest minorities from scratch.” by M. Fitzi, N. Gisin, U. M. Maurer, and O. von Rotz.

For example, the server devices may synchronize their lists by each of them sending their local list of transaction requests to each other. The agreed list may be the union of the requests in the received lists.

In an example embodiment of the present invention, any one or all of the server devices may export the agreed list of to a user. For example, a web page, or an API or the like of a server device may be configured for access to the agreed list. This can be used by a user to verify that the server devices are honest.

Moreover, a user could check if his submitted transaction request made it on to the list.

In an example embodiment of the present invention, a user, e.g., a client device, submits a transaction request to a server device. The server device sends a signed receipt back including a timestamp, or a block number. In this way the user can later prove that his transaction requests was submitted but did not make it to the list, or was not processed.

FIG. 3B schematically shows an example of an embodiment of a distributed ledger system. FIG. 3B shows a transaction request aggregator 331. Aggregator 331 may or may not be employed in system 300.

For example, all server devices may forward any transaction request that they receive to aggregator 331. Aggregator 331 may compile the transaction requests into a single aggregated list, e.g., culling duplicate requests, e.g., requests submitted to multiple servers. Aggregator 331 may periodically send the aggregated list to the server devices. Transactions in a new block may be selected from the aggregated list, in fact they may even be required to be selected from the aggregated list.

In an embodiment, aggregator 331 may be configured to submit a new transaction list to a distributed ledger system. The distributed ledger system may be a different system, but may even be the same distributed ledger system.

A client device, shown is client device 311, may contact aggregator 331 to obtain the current agreed list of transaction requests. If aggregator 331 sees a new block in the distributed ledger, the processed transactions, e.g., the transactions in the new block may be removed from the agreed list. The transaction may continue to be available from aggregator 331, e.g., to verify their age.

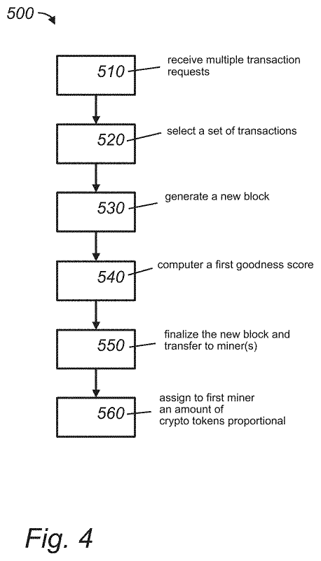

FIG. 4 schematically shows an example of an embodiment of a method 500 for maintaining a distributed ledger by a first miner. Method 500 comprises
receiving (510) multiple transaction requests for inclusion in the distributed ledger,
selecting (520) a set of transactions from the multiple transaction requests,
generating (530) a new block for the distributed ledger including the selected set of transactions,
computing (540) a first goodness score by evaluating compliance of the first miner to one or more selection rules, the one or more selection rules indicating rules for selecting transactions for a new block of the distributed ledger,
finalizing (550) the new block and transferring the block to one or more further miners, and
assigning (560) to the first miner an amount of cryptographic tokens proportional to the first goodness score.

For example, the method may be a computer implemented method. Many different ways of executing the methods are possible, as will be apparent to a person skilled in the art. For example, the order of the steps can be performed in the shown order, but the order of the steps can be varied or some steps may be executed in parallel. Moreover, in between steps other method steps may be inserted. The inserted steps may represent refinements of the method such as described herein, or may be unrelated to the method. For example, some steps may be executed, at least partially, in parallel. Moreover, a given step may not have finished completely before a next step is started.

Embodiments of the method may be executed using software, which comprises instructions for causing a processor system to perform method 500. Software may only include those steps taken by a particular sub-entity of the system. The software may be stored in a suitable storage medium, such as a hard disk, a floppy, a memory, an optical disc, etc. The software may be sent as a signal along a wire, or wireless, or using a data network, e.g., the Internet. The software may be made available for download and/or for remote usage on a server. Embodiments of the method may be executed using a bitstream arranged to configure programmable logic, e.g., a field-programmable gate array (FPGA), to perform the method.

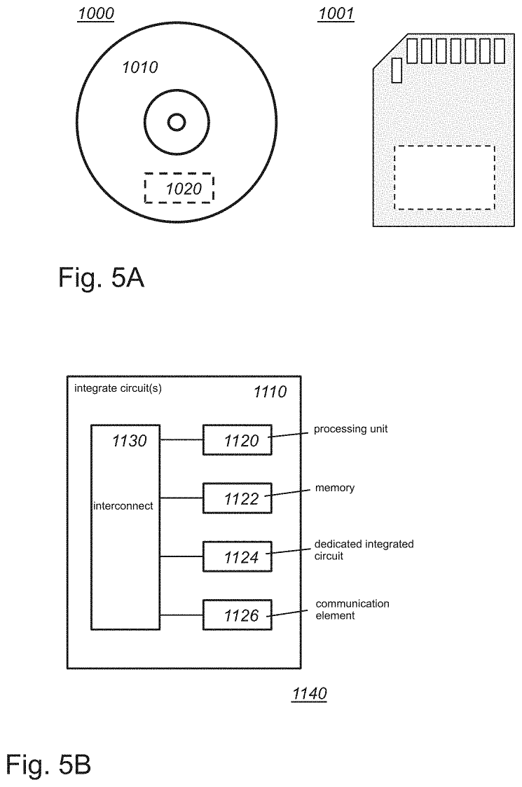

It will be appreciated that the presently disclosed subject matter also extends to computer programs, particularly computer programs on or in a carrier, adapted for putting the presently disclosed subject matter into practice. The program may be in the form of source code, object code, a code intermediate source, and object code such as partially compiled form, or in any other form suitable for use in the implementation of an embodiment of the method. An embodiment relating to a computer program product comprises computer executable instructions corresponding to each of the processing steps of at least one of the methods set forth. These instructions may be subdivided into subroutines and/or be stored in one or more files that may be linked statically or dynamically. Another embodiment relating to a computer program product comprises computer executable instructions corresponding to each of the devices, units and/or parts of at least one of the systems and/or products set forth. FIG. 5A shows a computer readable medium 1000 having a writable part 1010, and a computer readable medium 1001 also having a writable part. Computer readable medium 1000 is shown in the form of an optically readable medium. Computer readable medium 1001 is shown in the form of an electronic memory, in this case a memory card. Computer readable medium 1000 and 1001 may store data 1020 wherein the data may indicate instructions, which when executed by a processor system, cause a processor system to perform an embodiment of a method of maintaining a distributed ledger, according to an embodiment. The computer program 1020 may be embodied on the computer readable medium 1000 as physical marks or by magnetization of the computer readable medium 1000. However, any other suitable embodiment is possible as well. Furthermore, it will be appreciated that, although the computer readable medium 1000 is shown here as an optical disc, the computer readable medium 1000 may be any suitable computer readable medium, such as a hard disk, solid state memory, flash memory, etc., and may be non-recordable or recordable. The computer program 1020 comprises instructions for causing a processor system to perform said method.

FIG. 5B shows in a schematic representation of a processor system 1140 according to an embodiment of a device for maintaining a distributed ledger. The processor system comprises one or more integrated circuits 1110. The architecture of the one or more integrated circuits 1110 is schematically shown in FIG. 5B. Circuit 1110 comprises a processing unit 1120, e.g., a CPU, for running computer program components to execute a method according to an embodiment and/or implement its modules or units. Circuit 1110 comprises a memory 1122 for storing programming code, data, etc. Part of memory 1122 may be read-only. Circuit 1110 may comprise a communication element 1126, e.g., an antenna, connectors or both, and the like. Circuit 1110 may comprise a dedicated integrated circuit 1124 for performing part or all of the processing defined in the method. Processor 1120, memory 1122, dedicated IC 1124 and communication element 1126 may be connected to each other via an interconnect 1130, say a bus. The processor system 1110 may be arranged for contact and/or contact-less communication, using an antenna and/or connectors, respectively.

For example, in an embodiment, processor system 1140, e.g., a device for distributed ledger may comprise a processor circuit and a memory circuit, the processor being arranged to execute software stored in the memory circuit. For example, the processor circuit may be an Intel Core i7 processor, ARM Cortex-R8, etc. In an embodiment, the processor circuit may be ARM Cortex M0. The memory circuit may be an ROM circuit, or a non-volatile memory, e.g., a flash memory. The memory circuit may be a volatile memory, e.g., an SRAM memory. In the latter case, the device may comprise a non-volatile software interface, e.g., a hard drive, a network interface, etc., arranged for providing the software.

It should be noted that the above-mentioned embodiments illustrate rather than limit the presently disclosed subject matter, and that those skilled in the art will be able to design many alternative embodiments.

Use of the verb ‘comprise’ and its conjugations does not exclude the presence of elements or steps other than those stated. The article ‘a’ or ‘an’ preceding an element does not exclude the presence of a plurality of such elements. Expressions such as “at least one of” when preceding a list of elements represent a selection of all or of any subset of elements from the list. For example, the expression, “at least one of A, B, and C” should be understood as including only A, only B, only C, both A and B, both A and C, both B and C, or all of A, B, and C. The presently disclosed subject matter may be implemented by hardware comprising several distinct elements, and by a suitably programmed computer. In a device including several parts, several of these parts may be embodied by one and the same item of hardware. The mere fact that certain measures are described in separate embodiments does not indicate that a combination of these measures cannot be used to advantage.

What is claimed is:

1. A computer-implemented method for maintaining a distributed ledger by a first miner, the method comprising:
receiving multiple transaction requests for inclusion in the distributed ledger;
selecting a set of transactions from the multiple transaction requests;
generating a new block for the distributed ledger including the selected set of transactions;
computing a first goodness score by evaluating compliance of the first miner to one or more selection rules, the one or more selection rules indicating rules for selecting transactions for a new block of the distributed ledger;
finalizing the new block and transferring the block to one or more further miners; and
assigning to the first miner an amount of cryptographic tokens proportional to the first goodness score.

2. The method according to claim 1, the method further comprising:
receiving a block of the distributed ledger from a second miner;
computing a second goodness score of the second miner by evaluating compliance of the second miner to the one or more selection rules;
first verifying the transactions in the block against the distributed ledger;
second verifying that an amount of cryptographic tokens assigned to the second miner is proportional to the second goodness score; and
rejecting the block when any one of the first and second verifying fails.

3. The method according to claim 1, wherein transaction requests have an age, and wherein compliance is evaluated lower when transaction requests with an old age are not selected.

4. The method according to claim 1, wherein the assigned cryptographic tokens are obtained from:
new cryptographic tokens minted with the generation of the new block, and/or
transaction fees associated with the selected transactions.

5. The method according to claim 1, further comprising:
synchronizing transaction requests for inclusion in the distributed ledger with a second miner.

6. The method according to claim 1, further comprising generating a list of agreed transaction requests for inclusion in the distributed ledger with a set of miners, and selecting the set of transactions from the agreed transaction requests.

7. The method according to claim 6, wherein the compliance is evaluated lower when transaction requests with an older age in the agreed list are not selected.

8. The method according to claim 6, further comprising exporting the agreed list to a user.

9. The method according to claim 1, further comprising sending a signed receipt to a user when receiving a transaction request and/or including the transaction request in an agreed list of transaction.

10. The method according to claim 2, further comprising
comparing the computed second goodness score of the second miner to determined criteria, and triggering a punishment routine when the comparison fails.

11. A server device for maintaining a distributed ledger as a first miner, comprising:
a communication interface configured to receive multiple transaction requests for inclusion in the distributed ledger; and
a processor system configured to:
select a set of transactions from the multiple transaction requests,
generate a new block for the distributed ledger including the selected set of transactions,
compute a first goodness score by evaluating compliance of the first miner to one or more selection rules, the one or more selection rules indicating rules for selecting transactions for a new block of the distributed ledger,
finalize the new block and transfer the block to one or more further miners, and
assign to the first miner an amount of cryptographic tokens proportional to the first goodness score.

12. A client device for using a distributed ledger, the client device comprising
a communication interface configured to send a transaction request to a server device; and
a processor system configured to:
maintain a first wallet with crypto tokens,
send a transaction request to the server device, requesting transfer of an amount of crypto tokens from the first wallet to a second wallet,
wherein the server device is configured to select the transaction request from multiple transaction requests, generate a new block for the distributed ledger including the selected transaction, compute a first goodness score by evaluating compliance of the miner to one or more selection rules, finalize the new block and transferring the block to one or more further miners, and assign to the first miner an amount of cryptographic tokens proportional to the first goodness score.

13. A non-transitory computer readable medium on which are stored data representing instructions for maintaining a distributed ledger by a first miner, the instructions, when executed by a computer, causing the computer to perform the following:
receiving multiple transaction requests for inclusion in the distributed ledger;
selecting a set of transactions from the multiple transaction requests;
generating a new block for the distributed ledger including the selected set of transactions;
computing a first goodness score by evaluating compliance of the first miner to one or more selection rules, the one or more selection rules indicating rules for selecting transactions for a new block of the distributed ledger;
finalizing the new block and transferring the block to one or more further miners; and
assigning to the first miner an amount of cryptographic tokens proportional to the first goodness score.
